(19) United States
(12) Patent Application Publication
(10) Pub. No.: US 2009/0090011 A1
(43) Pub. Date: Apr. 9, 2009

(54) Powered line trimmer attachment

(76) Inventors: Terry Gosschalk, Gleniffer (AU); Terence James Walker, Bellingen (AU)

Correspondence Address: Terry Gosschalk, 664 Timboon Road, Gleniffer, 2454, AU

(21) Appl. No.: 12/231,042

(22) Filed: Aug. 29, 2008

(30) Foreign Application Priority Data
Oct. 3, 2007 (AU) 2007905399

(51) Int. Cl. A01D 34/62; F16M 3/00; A01D 34/416

(52) U.S. Cl. 30/296.1; 56/17.1; 248/646

(57) ABSTRACT

A wheeled device suitable for supporting and stabilizing a powered lawn trimming device. The wheels steer by a castor action where they rotate about a vertical axis in response to the operator's direction. The wheels are positioned at the ends of two outrigger arms positioned one each side of the cutting head of the line trimmer. The wheeled assembly is clamped onto the line trimmer shaft in such a way as to provide means for height adjustment and adaptation to the different styles of lawn trimming devices.

This invention is suitable for attachment to a straight or bent shaft line trimmer of the type used in lawn care. The device when assembled can be easily fitted to the shaft of a line trimmer. The device can be fitted to or removed from the line trimmer in less than a minute. The device carries the weight of the line trimmer at the cutting head greatly reducing arm fatigue. The trimming of driveway, path and garden edging can be done with ease and with the simple height adjustment lawns and steep banks can be mown with little effort for example.

The device comprises two shaped metal arms with a shaped metal plate fixed to the inner end of each and a castor wheel assembly attached on the outer end of each.

The two arms are aligned with the two bolts in one of the arms and two holes in the other, two nuts fix the two arms firmly together.

The outer ends of the arms have two holes in each end. The castor assemblies can be fitted into the outer holes for use with a straight shaft line trimmer or the inner holes for a bent shaft line trimmer.

The plates on the inner ends of the arms when fixed together present the required facing for alignment on the line trimmer shaft. The device is attached to the line trimmer shaft by a clamp.

The clamp needs only to be loosened to slide the device up or down the shaft to achieve the required cutting height.

To assist with understanding the invention, reference will now be made to the accompanying drawings which show examples of the invention.

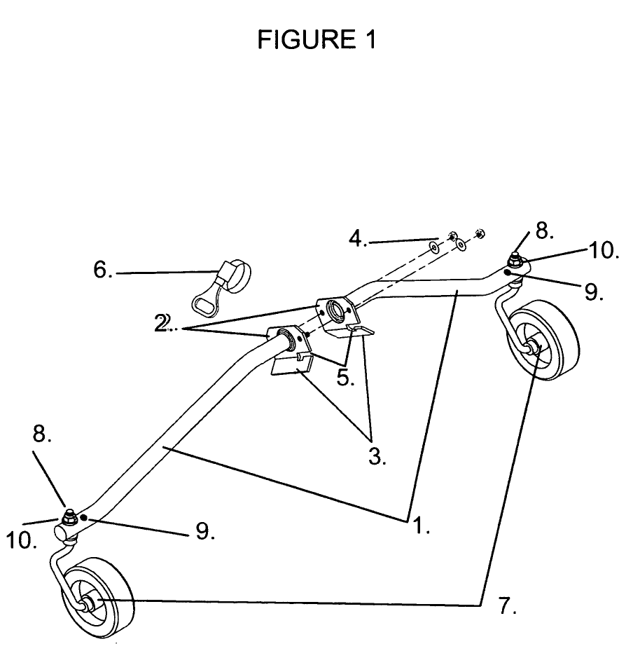

FIG. 1. Shows an exploded pictorial view of a preferred example of the device according to this invention.

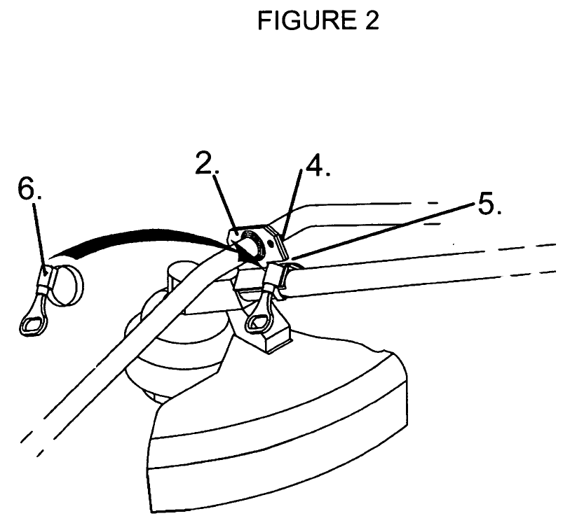

FIG. 2. Shows the device attached to the straight shaft line trimmer

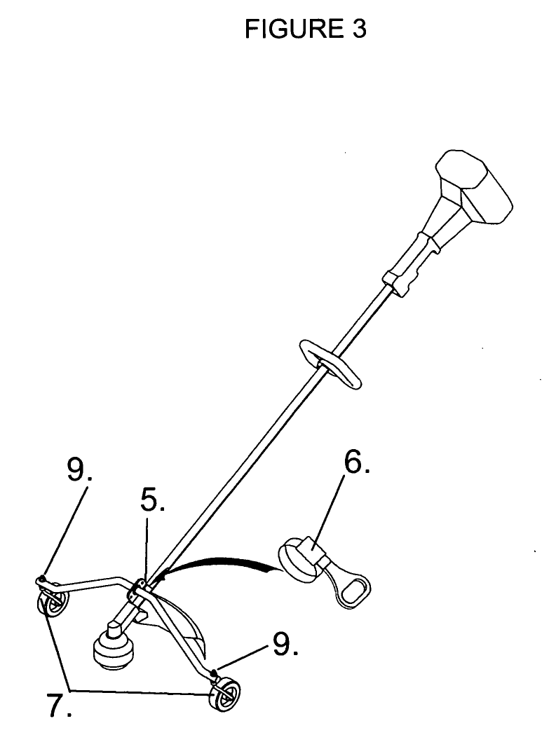

FIG. 3. Shows an alternative view of the device attached to the straight shaft line trimmer

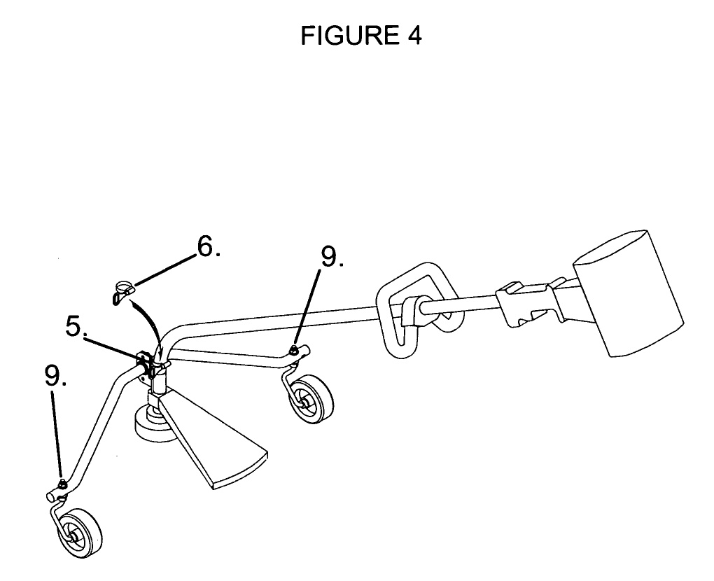

FIG. 4. Shows the device mounted on the bent shaft line trimmer.

This invention is an improvement on other similar devices known commonly as line trimmer attachments by way of the assembly and self alignment of the inner plates to provide ease of attachment and or removal from the line trimmer shaft, also the simplicity of the single action height adjustment.

To assist with understanding the invention, reference will now be made to the accompanying drawings which show examples of the invention.

REFERRING TO FIG. 1 The two arms 1 are of a shape so as to achieve a height and width clearance from the cutting head of the line trimmer.

The inner plates 2 are fixed permanently to the shaped arms 1 and each has an angular lower face 3. When aligned and fixed together by way of the bolts and nuts 4 they present a suitable shape for secure attachment to the line trimmer shaft. The slots 5 in the upper end of the plates retain the a clamp 6 which when tightened aligns the device onto the shaft of the line trimmer.

The castor assemblies 7 are fitted into either of the two holes in the outer end of each arm. The outer holes 8 as in this example provide the correct castor alignment for use on the straight shaft line trimmer, and the inner holes 9 for use on the bent shaft line trimmer. The castors are secured by the nuts 10.

REFERRING TO FIG. 2 Shows the two inner plates 2 fixed together by the bolts, washers and nuts 4 ready for mounting onto the line trimmer shaft. The clamp 6 is placed onto the shaft of the line trimmer and located into the slot 5 and tightened. The clamp 6 can be loosened allowing the device to be moved up or down the shaft to achieve height adjustment and re-tightened.

REFERRING TO FIG. 3 Shows the device attached to a straight shaft line trimmer by way of the clamp 6 mounted on the line trimmer shaft and located into the slot 5. The castor assemblies 7 have been fitted into the outer holes 9 for correct alignment when using the straight shaft line trimmer.

REFERRING TO FIG. 4 Shows the device attached to a bent shaft line trimmer by way of the clamp 6 mounted on the line trimmer shaft and located into the slot 5. The castor assemblies have been fitted into the inner holes 9 for correct alignment when using the bent shaft line trimmer.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

1. A wheeled device suitable for supporting and stabilizing powered gardening equipment, such wheels steer by a castor action where they rotate about a vertical axis in response to the operator's direction,
the wheels being positioned at the ends of two outrigger arms positioned one each side of the cutting head of the gardening device and,
wherein the assembly/dismantling method provides for compact storage, and,
alternative choice of assembly method accommodates different styles of gardening equipment and,
mounting method providing also means for grass cutting height adjustment.

2. A wheeled device according to claim 1 wherein the supported gardening equipment is a lawn trimming device.

3. A wheeled device according to claim 1, being clamped onto the shaft of the lawn trimming device using hand operated clamps.

4. A tool device substantially as herein before described with reference to FIGS. 1-4 of the accompanying drawings.
